(19) United States
(12) Patent Application Publication
(10) Pub. No.: US 2026/0093473 A1
(43) Pub. Date: Apr. 2, 2026

(54) STORAGE SYSTEM REPURPOSING WITH PRESERVATION OF CLUSTER CONFIGURATION DELTAS AND DATA IN-PLACE

(71) Applicant: Dell Products L.P., Round Rock, TX (US)

(72) Inventors: Steven Soumpholphakdy, Austin, TX (US); Anton Rang, Houlton, WI (US); David T. Leimbach, Everett, WA (US)

(21) Appl. No.: 18/903,522

(22) Filed: Oct. 1, 2024

(51) Int. Cl. G06F 8/65; G06F 8/61; G06F 9/4401

(52) U.S. Cl. CPC G06F 8/65; G06F 8/63; G06F 9/4406

(57) ABSTRACT

A method facilitating storage system repurposing with preservation of cluster configuration deltas and data in-place includes removing, by a node device including at least one processor, a volume associated with the node device from a file system of a computing cluster in which the node device operates in response to an operating system upgrade instruction being received by the node device; in response to determining that the volume has successfully been removed from the file system of the computing cluster, populating, by the node device, a partition of the volume with cluster configuration data representative of a configuration of the computing cluster; and booting, by the node device based on the cluster configuration data as stored on the partition of the volume, the node device from an operating system image installed on the volume.

### BACKGROUND

As computing technology advances, new operating systems, software applications, and the like are being developed to enhance user experience, provide new features, improve security, and provide other benefits. As these operating systems and/or other software become available, it is desirable to provide techniques to facilitate converting existing computing devices in operation to the new software while maintaining existing data and with minimal disruption to the systems in which the devices operate.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include removing a storage drive, of a node device of a computing system, from a file system used by the computing system in response to receiving an operating system upgrade instruction for the node device. In response to determining that the storage drive has successfully been removed from the file system, the operations can further include populating a partition of the storage drive with system configuration data representative of a configuration of the computing system. The operations can additionally include booting, based on the system configuration data as stored on the partition of the storage drive, the node device from an operating system image installed on the storage drive.

In another implementation, a method is described herein. The method can include removing, by a node device including at least one processor, a volume associated with the node device from a file system of a computing cluster in which the node device operates in response to an operating system upgrade instruction being received by the node device. In response to determining that the volume has successfully been removed from the file system of the computing cluster, the method can additionally include populating, by the node device, a partition of the volume with cluster configuration data representative of a configuration of the computing cluster. The method can also include booting, by the node device based on the cluster configuration data as stored on the partition of the volume, the node device from an operating system image installed on the volume.

In an additional implementation, a non-transitory machine-readable medium is described herein that can include instructions that, when executed by at least one processor, facilitate performance of operations. The operations can include removing, in response to receiving an operating system upgrade instruction, a volume of a computing device from a file system of a computing cluster in which the computing device operates; in response to determining that the volume has successfully been removed from the file system of the computing cluster, populating a partition of the volume with cluster configuration data representative of a configuration of the computing cluster; and booting, based on the cluster configuration data, the computing device from an operating system image installed on the volume.

### DESCRIPTION OF DRAWINGS

Various non-limiting embodiments of the subject disclosure are described with reference to the following figures, wherein like reference numerals refer to like parts throughout unless otherwise specified.

FIGS. 1-6 are block diagrams of respective systems that facilitate storage system repurposing with preservation of cluster configuration deltas and data in-place in accordance with various implementations described herein.

FIGS. 7-10 are diagrams illustrating example operations that can be performed on a node device operating in a clustered file system in accordance with various implementations described herein.

FIGS. 11-13 are diagrams illustrating respective procedures that can be utilized in connection with one or more implementations described herein.

FIGS. 14-15 are flow diagrams of respective methods that facilitate storage system repurposing with preservation of cluster configuration deltas and data in-place in accordance with various implementations described herein.

FIG. 16 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

As advancements to the software framework of computing devices (e.g., operating systems, file systems, software applications, etc.) become available, it is desirable to provide ways to convert existing computing devices from their existing software systems to newer systems. More particularly, with regard to this conversion process, it is desirable to develop a framework for existing operating systems to better facilitate upgrades, to determine where to place new software system content related to an upgrade in the event that existing devices have root partition size limitations, to provide mechanisms to be able to roll back an upgrade if necessary, and to facilitate upgrading devices on a live cluster while maintaining existing data.

Before a new operating system or other software system is released, it is desirable to release changes to existing operating systems to facilitate the conversion process. However, because unforeseen problems often arise during the rollout of new software systems, it is further desirable to provide a framework that enables controlling, from the target payload, the steps to take for the conversion process while devices are still running on the existing software.

When a system is ready to proceed with the conversion process, a data payload corresponding to the new software can be deposited to respective devices of the system, e.g., to enable the devices to boot from the new software. In some existing operating systems, devices do not have dedicated boot drives and instead reserve areas of data drives for system root partitions. In the event that a device running such an operating system is to be upgraded to a new operating system that is larger than the size of this reserved area, it is desirable for the conversion process to create space for the installation and ensure that, after the conversion, there is redundancy with the boot volume (e.g., such that there is no single point of failure).

Additionally, in the event that the upgrade is to be rolled back, it is further desirable to ensure that any configuration level changes made once booted into the new operating system are still reflected when the system goes back to the previous operating system.

To the furtherance of the above and/or related ends, implementations described herein can provide a process to upgrade the operating system and/or other software components of a computing device while addressing each of the above items, e.g., by implementing a sequence of actions that can be initiated to convert a node from an existing operating system to a new operating system. This process can be repeated until all nodes in an associated cluster are converted, at which point a commit-like step can be performed to finalize the upgrade (e.g., at which point no rollback can be performed).

By utilizing one or more implementations as described herein, upgrades to the operating systems and/or other software components of a group of computing devices, e.g., computing devices operating in a computing cluster, can be performed using automated processes that can operate at a higher level of complexity than is possible to be performed manually by a human, e.g., due to the number of calculations and/or other operations performed in parallel, the number of devices that can be upgraded simultaneously, and/or other factors. Additionally, implementations described herein can facilitate automation of highly technical tasks that are inherently and/or inextricably tied to computer technology and cannot be implemented outside of a computing environment, such as tasks associated with disk partition management, data migration, software configuration and installation, or other aspects of computing system management. As a result, by utilizing one or more automated techniques facilitated by implementations described herein, an end user can be given the ability to perform upgrade tasks for an associated computing system, e.g., by simply pressing a button on a user interface, inputting a simple command, or performing other comparable actions, even if that user lacks the requisite knowledge to perform those tasks manually. Similarly, if problems are encountered during the upgrade process, implementations described herein can facilitate automated techniques that can give an end user the ability to reverse the upgrade process by performing comparable actions that do not require specific knowledge on the part of the user of the upgrade process and/or the error(s) encountered during that process.

With regard to the following description, it is noted that any references to specific operating systems, software applications, or the like, are made merely by way of example and are not intended to limit the scope of the description or the claimed subject matter unless explicitly stated otherwise. For instance, while various examples provided herein relate to examples involving conversion of a Berkeley Software Distribution (BSD)-based system to a Linux-based system, it is noted that similar concepts to those described herein could also be applied to facilitate conversion to and/or from other system types, either in addition to or in place of the named system types.

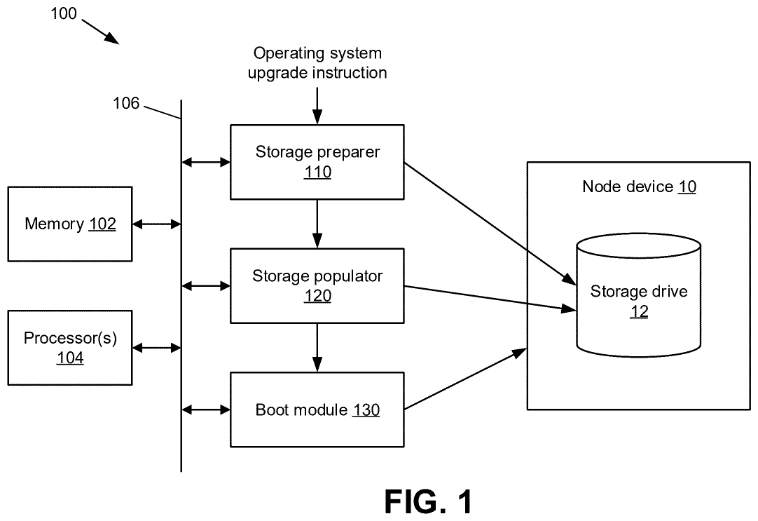

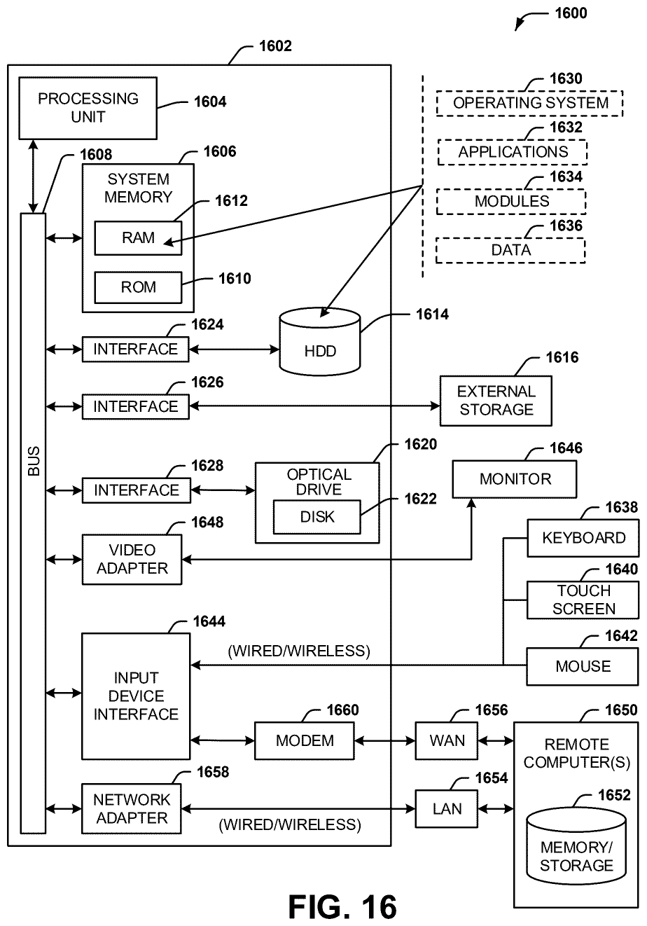

With reference now to the drawings, FIG. 1 illustrates a block diagram of a system 100 that facilitates storage system repurposing with preservation of cluster configuration deltas and data in-place in accordance with various implementations described herein. System 100 as shown in FIG. 1 includes executable components, e.g., a storage preparer 110, a storage populator 120, and a boot module 130, each of which can operate as described in further detail below. In an implementation, the components 110, 120, 130 of system 100 can be implemented in hardware, software, or a combination of hardware and software. By way of example, the components 110, 120, 130 can be stored on at least one memory (e.g., a memory 102) and executed by at least one processor (e.g., processor(s) 104). An example of a computer architecture including a processor and memory that can be used to implement the components 110, 120, 130, as well as other components as will be described herein, is shown and described in further detail below with respect to FIG. 16. As further shown in FIG. 1, the executable components 110, 120, 130, the memory 102, the processor 104, and/or other elements of system 100 can communicate with each other via a bus 106 and/or other components that provide intercommunication between various elements of system 100.

Additionally, it is noted that the functionality of the respective components shown and described herein can be implemented via a single computing device and/or a combination of devices. For instance, in various implementations, the storage preparer 110 shown in FIG. 1 could be implemented via a first device, the storage populator 120 could be implemented via the first device or a second device, and the boot module 130 could be implemented via the first device, the second device, or a third device. Also, or alternatively, the functionality of a single component could be divided among multiple devices in some implementations.

As will be described in further detail below, the components 110, 120, 130 of system 100 can interact with one or more node devices 10, such as a physical or virtual computing device associated with a computing cluster utilizing a clustered file system. It is noted that the components 110, 120, 130 could themselves be implemented as part of the node device 10, or alternatively one or more devices implementing system 100 could be separate from the node device 10 and communicate the node device 10 through any suitable wired and/or wireless communication technology(-ies).

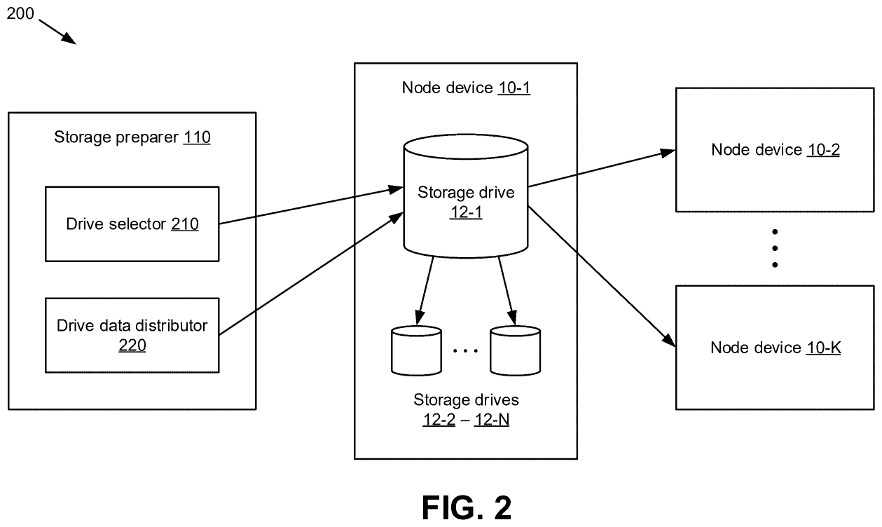

With reference now to the components of system 100, the storage preparer 110 can remove a storage drive 12, of a node device 10 of a computing system, from a file system used by the computing system in response to receiving an operating system upgrade instruction for the node device 10. As used herein, a storage drive 12 can also be referred to as a disk, a volume, a storage device, and/or by any other suitable nomenclature. As part of this process, the storage preparer 110 can also take one or more actions to ensure that any data stored on the storage device 12 prior to the operating system upgrade is migrated to one or more other drives or computing devices, e.g., as described in further detail below with respect to FIG. 2.

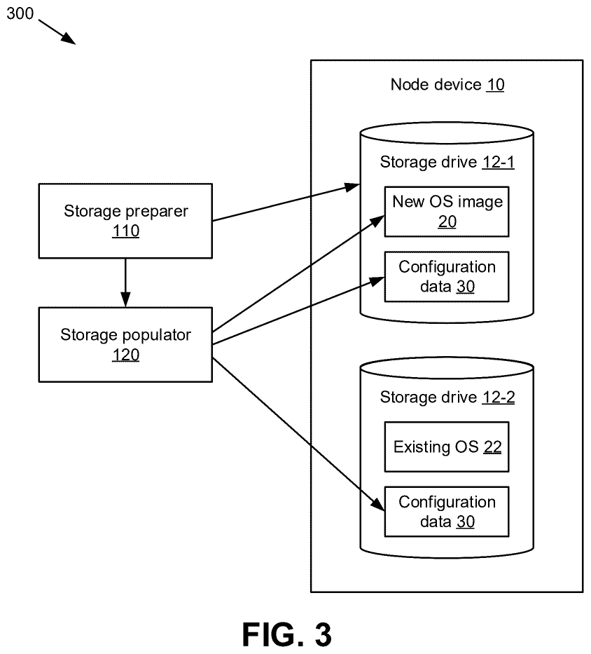

The storage populator 120, in response to determining that the storage drive 12 has successfully been removed from the file system of the computing system by the storage preparer 110, can populate a partition of the storage drive 12 with system configuration data representative of a configuration of the computing system. Based on this system configuration data as stored on the partition of the storage drive 12 by the storage populator 120, the boot module 130 can boot the node device 10 from an operating system image installed on the storage drive 12, e.g., by the storage populator 120 as described in further detail below with respect to FIG. 3.

In an implementation, the system configuration data that can be written to the storage drive 12 of the node device 10 by the storage populator 120 can correspond to a state of the node device 10, and/or the system in which the node device 10 operates, as represented in a snapshot or other system view that is taken just prior to the boot module 130 booting the node device 10 into the new operating system. This can be done, for example, to ensure that there is no time gap where possible changes to the system state could occur between the time at which the operating system upgrade is initiated and the time that the node device 10 goes down to boot the new operating system.

In some implementations, the starting point for a conversion method that can be performed via system 100 is a computing cluster with node devices 10 on a version of a first operating system, e.g., a version of a BSD-based operating system, that is compatible with a second operating system, e.g., a Linux-based operating system. As used herein, compatibility of an operating system image (of a first operating system) with a second operating system is defined by the ability of the operating system image to (1) Join a cluster running the second operating system as a node on the first operating system with the ability to service reads/writes in this state, and (2) have all the content and/or logic to be able to convert itself to the second operating system. In the event that a computing cluster has one or more node devices 10 running a version of the first operating system that is not compatible with the second operating system, these node devices 10 can be upgraded to a compatible version of the first operating system prior to operation of system 100.

To start the conversion process for a given node device 10 from a compatible version of a first operating system to a second operating system, the storage preparer 110 can free up space on a storage drive 12 of the node device 10 such that a payload containing data related to the second operating system can be deposited, e.g., by the storage populator 120, onto the storage drive 12. Techniques for selecting and freeing space on the storage drive 12 are described in further detail below with respect to FIG. 2, and techniques for writing a data payload to the storage drive 12 are described in further detail below with respect to FIG. 3.

In an implementation, the payload deposited by the storage populator 120 can include all of the files utilized in completing the conversion process. At the start of the conversion process, the storage populator 120 can unpack this payload and find a file within the payload that can provide a listing of steps associated with performing the conversion. These steps can include, e.g., respective actions that are to be performed ahead of booting into the second operating system, e.g., by the boot module 130. On the compatible version of the first operating system (e.g., as running on the node device 10 prior to conversion), a framework can be put into place that can unpack the payload, find the conversion file, and execute the steps identified in that file. The steps in the conversion can include, but are not limited to, command line steps (e.g., FreeBSD commands, etc.) and/or copying of payload files onto the existing node device 10 and/or its cluster. Having a generic framework such as the above in place at the node device 10 can enable the node device 10 to execute any type of desired command, execute scripts that are not resident on the current version of its existing operating system, enable the definition of a conversion process in a compatible version of its existing operating system, and override, inject, and/or change behavior as desired via scripts.

Turning now to FIG. 2, a block diagram of another system 200 that facilitates is illustrated. Repetitive description of like parts described above with regard to other implementations is omitted for brevity. As shown in FIG. 2, the node device 10 shown in FIG. 1 is a first node device 10-1 of a computing cluster that includes K node devices 10-1 through 10-K. Additionally, the storage drive 12 shown in FIG. 1 is shown in FIG. 2 as a first storage drive 12-1 of the first node device 10-1, which operates as part of N storage drives 12-1 through 12-N of the node device 10-1. It is noted that the numbering conventions used for the node devices 10 and storage drives 12 is not intended to imply any specific number of node devices 10 and/or storage drives 12, as a cluster could contain any suitable number of node devices 10, including one device or multiple devices, and each of these node devices 10 could include any number(s) of storage drives 12, including one drive or multiple drives.

System 200 as shown in FIG. 2 includes a storage preparer 110, which can operate as described above with respect to FIG. 1. In addition, the storage preparer 110 of system 200 includes a drive selector 210, which can select a storage drive 12, here storage drive 12-1, from a group of storage drives 12 of the node device 10-1 based on one or more criteria as will be described below. The storage preparer 110 of system 200 further includes a drive data distributor 220, which can facilitate migration of data stored on the selected storage drive 12-1 to other storage drives 12-2 through 12-N of the node device 10-1, and/or other node devices 10-2 through 10-K of the cluster, as described in further detail below.

As part of the conversion process described above with respect to FIG. 1, the storage preparer 110 can provide a way to free up space on one or more storage drives 12 of a node device 10-1 for an updated operating system image. In some implementations, the storage drives 12 of the node device 10-1, prior to conversion, can have reserved space that is used to move around root partitions as necessary (e.g., due to firmware updates, drive failures, etc.) to ensure that there is no single point of failure for the operating system as installed on the node device 10-1. If the new operating system image is larger than these reserved sizes, the storage preparer 110 can facilitate freeing up an entire storage drive 12-1.

To facilitate freeing an entire storage drive 12-1 at the node device 10-1, the drive selector 210 can select a storage drive 12-1 as the drive of the node device 10-1 to be freed, e.g., based on whether there are any storage drives 12 of the node device 10-1 that do not contain any root partitions or other mirrored partitions. For instance, in response to determining that a storage drive 12-1 of the node device 10-1 does not contain any partitions that are mirrored to other node devices 10-2 through 10-K, the drive selector 210 can select that storage drive 12-1 for removal from the file system of the node device 10-1. Alternatively, if all storage drives 12 of the node device 10-1 have a mirrored partition, the drive selector 210 can select one of the storage drives 12, e.g., storage drive 12-1, after which the drive data distributor 220 can move the mirrored partition on that drive to another drive, or another node device in the cluster, to prepare the storage drive 12-1 for removal from the file system of the node device 10-1.

In an implementation, the storage preparer 110 can remove the storage drive 12-1 from the file system of the node device 10-1 via a data re-protection procedure in which, prior to the storage drive 12-1 being removed from the file system, any stored contents of the storage drive 12-1 are migrated by the drive data distributor 220 to other storage drives 12-2 through 12-N of the node device 10-1, and/or other node devices 10-2 through 10-K of the cluster. Subsequent to data migration and re-protection, the storage preparer 110 can wipe the selected storage drive 12-1, e.g., by removing any existing partitions on the storage drive 12-1.

Once sufficient free space has been created on a storage drive 12-1 of the node device 10-1 as shown in FIG. 2, the new operating system payload can be put onto the storage drive 12-1 by the storage populator 120, e.g., as shown by system 300 in FIG. 3. For instance, as FIG. 3 illustrates, the storage populator 120 can install a new operating system image 20 onto one or more partitions of the storage drive 12-1, e.g., one or more root partitions created by the storage populator 120 for this purpose, in response to determining that the storage drive 12-1 has successfully been removed from the file system of the node device 10.

As a result of the new operating system image 20 being installed on the storage drive 12-1 of the node device 10, the storage drive 12-1 can have a bootable form of the new operating system available to it. In some implementations, the node device 10 can be capable of dual booting at this stage, e.g., from either the new operating system image 20 installed on the storage drive 12-1 or an existing operating system 22 (e.g., a different operating system installed on the node device 10 prior to the conversion) installed on, and/or otherwise executed from, a different storage drive 12-2.

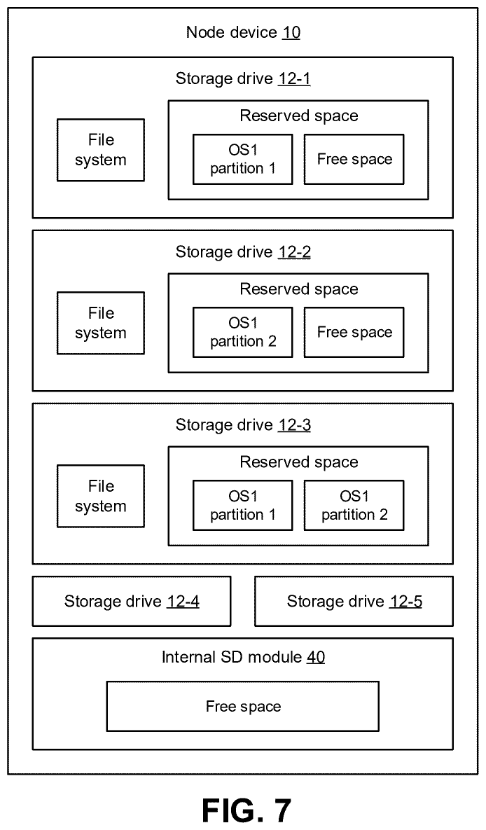

As further shown by FIG. 3, the storage populator 120 of system 300 can provide a mechanism to carry forward cluster configuration data 30 through the conversion process. This cluster configuration data 30 can include, e.g., any feature level configuration as well as any other configuration information associated with the cluster in which the node device 10 resides. To achieve this, the storage populator 120 can create a new partition on the storage drive 12-1 where bootstrap, configuration, and state information, and/or other suitable information, can reside. As used herein, the cluster configuration data 30 is also referred to as system state data, e.g., with reference to FIGS. 7-10 below. As further shown in FIG. 3, the partition containing configuration data 30 can also be mirrored to one or more other storage drives, e.g., storage drive 12-2 and/or other drives on the node device 10 or other node devices, by leveraging free space in reserved areas on other drives. In an implementation, the partitions created for configuration data 30 as shown in FIG. 3 can be of a format, e.g., FAT32 or the like, that is readable by both the new operating system image 20 and the existing operating system 22.

Once the operations shown in FIG. 3 have been performed, the node device 10 is ready to boot from the new operating system image 20. In an implementation, the new operating system image 20 can be compatible with the existing operating system 22 shown in FIG. 3, meaning that once the node device 10 has booted into the new operating system image 20 and relevant services have been started, the cluster should not appear degraded and will continue to serve reads and writes regardless of whether those reads/writes land on a node running the new operating system image 20 or the existing operating system 22.

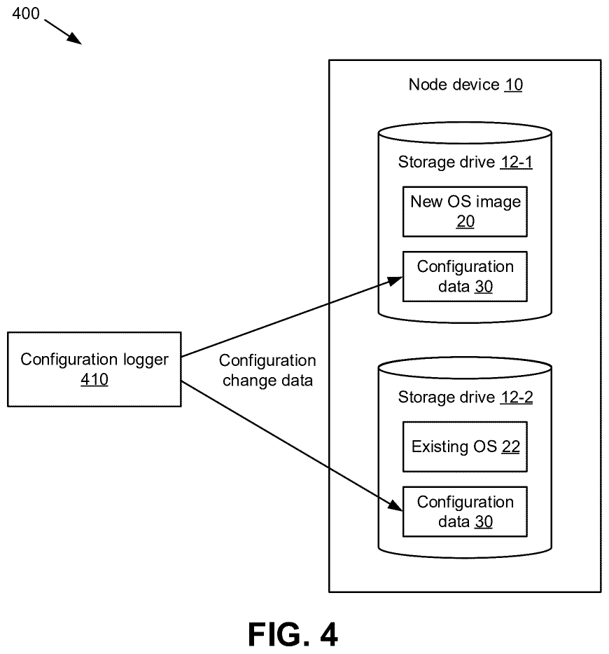

Turning next to FIG. 4, a system 400 that facilitates maintaining configuration change data (configuration deltas) subsequent to the new operating system image 20 being installed on the storage drive 12-1 of the node device 10. As shown in FIG. 4, system 400 includes a configuration logger 410 that can record configuration change data, representative of changes to a configuration of a computing system in which the node device 10 operates after the node device boots from the new operating system image 20, to the partition(s) of the storage drive(s) 12 containing configuration data 30, e.g., as described above with respect to FIG. 3.

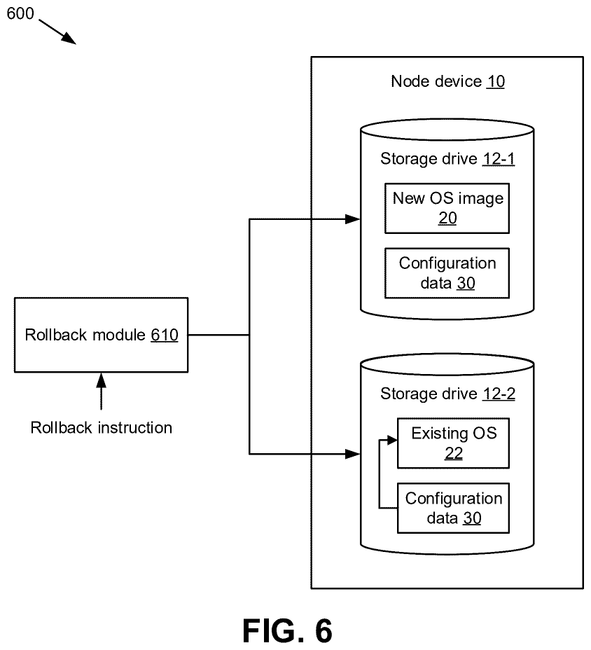

Once the node device 10 shown in FIG. 4 is booted on the new operating system image 20, the configuration logger 410 can export feature level configuration data based on the services of the node device 10 running on the new operating system. The configuration logger 410 can also be capable of interpreting any cluster configuration files such that if any updates are made, they are reflected back in a way that can be interpreted by the existing operating system 22 in the event of a rollback. This can be done, e.g., to ensure that if there is a rollback to the existing operating system 22, no changes or updates to the cluster state are lost. Techniques that can be utilized to facilitate a rollback to the existing operating system 22 are described in further detail below with respect to FIG. 6.

Once the node device 10 has been successfully converted to the new operating system image 20, it can be able to co-exist with other node devices in its cluster since the new operating system image 20 is compatible with the existing operating system 22. Once all nodes in the cluster have been converted, a commit step can be performed to finalize the conversion to the new operating system image 20.

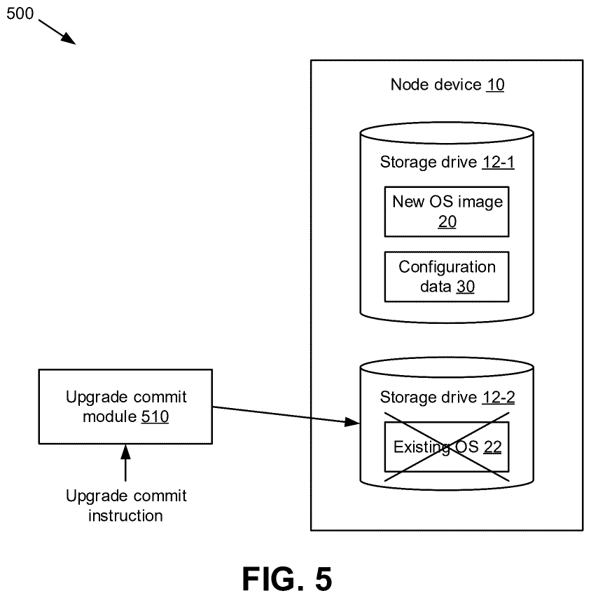

With reference next to FIG. 5, a system 500 that facilitates performance of the above-mentioned commit step for the node device 10 is illustrated. System 500 as shown in FIG. 5 includes an upgrade commit module 510 that, in response to receiving an upgrade commit instruction (e.g., after all node devices 10 have been upgraded successfully), can remove the previously existing operating system 22 from one or more storage drives 12 of the node device 10, e.g., storage drive 12-2 as shown in FIG. 5, on which the existing operating system 22 is located. Subsequent to the upgrade commit module 510 executing the commit instruction as shown in FIG. 5, the upgrade is final and rollbacks can no longer be performed.

As part of the commit step shown in FIG. 5, the upgrade commit module 510 can also ensure that the node device 10 has redundancy with its boot devices. This can involve, e.g., reclaiming space from storage drives 12 other than those on which the new operating system image 22 is installed, e.g., storage drive 12-2 or others, to mirror partitions associated with the new operating system.

In an implementation, the upgrade commit module 510 can finalize the upgrade process by taking steps to ensure that the node device 10 resembles a “ready node” that ships out of the factory. This step can include, e.g., finding a storage device on the node device 10 and including a bootable installer of the previous operating system and an install.tar payload that is the version of the previous operating system that is compatible with the new operating system. By doing so, each node device 10 on the new operating system can be structured to resemble each other.

In various implementations, a “ready node” can be defined as a node device that meets one or more of the following conditions:
1) By default, the node device boots the new operating system from data drives in the node.
2) On a separate device (e.g., a data drive or an additional drive in the system), a bootable installer of the old operating system and an install. tar payload that contains the content of the old operating system that is compatible with the new operating system are present.

An example of converting a node device to a ready node in this manner is described in further detail below with respect to FIGS. 7-10.

Once the above steps have been completed, each node device 10 in the cluster can be converted from their previous operating system to a new operating system while leaving their data in place.

Turning to FIG. 6, a system 600 that facilitates rolling a node device 10 back to a previously existing operating system 22 is illustrated. System 600 includes a rollback module 610 that, in response to receiving a rollback instruction, can boot the node device 10 from a previous operating system image 22, e.g., instead of a new operating system image 20 as described above. Additionally, the rollback module 610 can facilitate booting the node device 10 in this manner based on configuration data 30, e.g., as recorded by the storage populator 120 as described above with respect to FIG. 3 and/or a configuration logger 410 as described above with respect to FIG. 4, to ensure that no changes to the configuration of the node device 10 or its cluster made since initiation of the conversion procedure are lost.

By utilizing one or more implementations as described herein, storage space associated with a node device 10 in a computing cluster can be repurposed, e.g., to set the node device 10 up for dual booting. For instance, in order to be able to boot into an updated operating system, implementations provided herein can reclaim space from a drive of the device such that the new operating system can boot from that drive. The steps to do so are described in connection with implementations provided above, including finding a drive that is not being used as a boot mirror and removing it from the file system of the cluster, then restructuring the partitions of the drive such that a bootable payload can be put onto the device along with other relevant partitions to enable the upgrade, such as a system state partition. If all drives are being used for mirrored partitions, a drive can still be removed from the cluster file system, and the mirrored partitions can be pivoted to other drives with available space such that the drive can be used to boot the new operating system.

Additionally, implementations provided herein can facilitate maintenance and sharing of configuration across multiple operating systems to allow for upgrading and rollback between them. As part of preparing to boot into a new operating system, implementations described herein can utilize a partition type that is supported by both operating systems associated with a conversion process as described above, e.g., to store configuration files and/or other information. The current version of the existing operating system on the node device 10 can know to look for this alternate location. The new operating system can also be aware of this location, e.g., such that if any configuration changes are made while on the new operating system, those changes will persist if the device is rolled back to the old operating system.

With reference now to FIGS. 7-10, respective steps of a process for converting a node device 10 from a first operating system, e.g., a FreeBSD-based operating system, to a second operating system, e.g., a Linux-based operating system, are illustrated. More particularly, FIGS. 7-10 illustrate respective states of a node device 10 during an upgrade process that can cycle through multiple node devices, e.g., node devices operating in a cluster, in the same manner as that shown by FIGS. 7-10. With regard to FIGS. 7-10, it is noted that the number of storage drives 12 shown with reference to the node device 10, as well as the contents of those storage drives 12, are intended merely as a non-limiting example of a node conversion process and are not intended to limit any of the description provided herein to any particular type of node device, number of storage drives, or other properties.

Referring first to FIG. 7, an initial state of a node device 10, e.g., prior to conversion, is illustrated. The node device 10 in FIG. 7 contains a group of storage drives 12, each of which can contain file system partitions as well as reserved space for mirrored partitions. As used in FIGS. 7-10, this original operating system is referred to as “operating system 1” or OS1. Partitions associated with OS1 as shown in FIG. 7 can include, e.g., FreeBSD partitions such as a /root partition and/or a /var partition, or other suitable partitions. By way of example, “partition 1” as shown in FIG. 7 can correspond to a /var partition, and “partition 2”can refer to a /root partition. Other partition configurations could also be used.

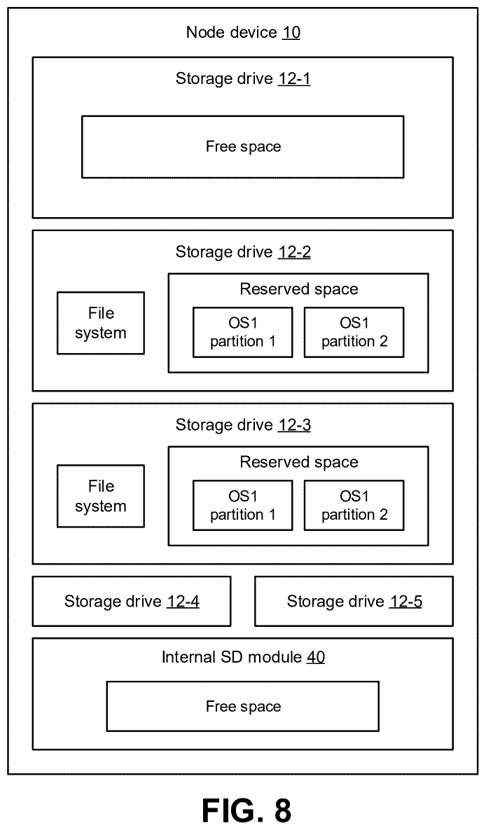

Turning to FIG. 8, the conversion process can create enough free storage space on the node device 10 to create a bootable disk for the new operating system. As shown in FIG. 8, this can be done by removing a drive, here storage drive 12-1, from the file system of the cluster. The outcome of the step shown in FIG. 8 is that data stored on storage drive 12-1 can be re-protected to other drives, and any mirrored partitions on storage drive 12-1 can be moved to another drive, e.g., storage drives 12-2 and 12-3 as shown in FIG. 8. As a result of the step shown in FIG. 8, the node device 10 now has a free drive to boot the new operating system.

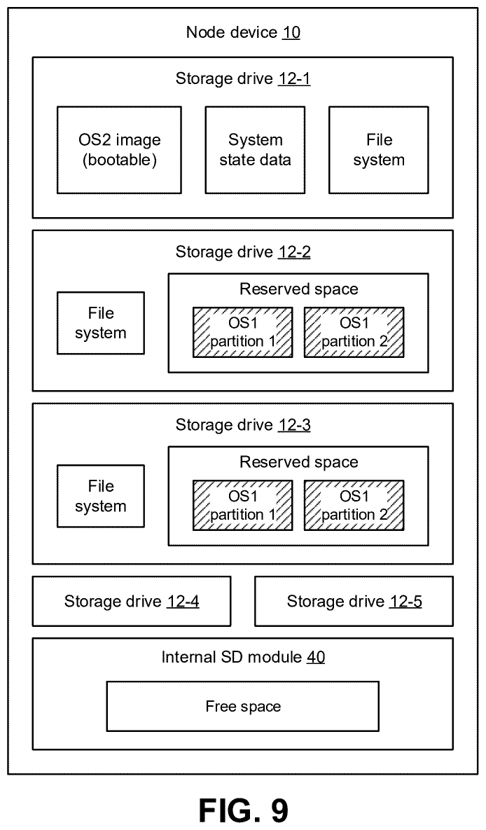

Referring next to FIG. 9, prior to converting the node device 10 to the new operating system, the drive cleared as shown in FIG. 8 can be prepared to boot the new operating system. In the example shown in FIG. 9, relevant portions of an operating system image corresponding to the new operating system, shown in FIG. 9 as “operating system 2” or OS2, can be placed onto the storage drive 12-1. Additionally, a system state partition can be created on storage drive 12-1 that enables the conversion process to include any bootstrap/configuration data to be used when the node device 10 is booted into the new operating system, e.g., to keep the identity of the node device 10. This system state partition can be mirrored to one or more other storage drives 12 in a way that is readable by both the existing and new operating systems, e.g., to ensure that the system state is maintained in the event of a rollback. Once the preparations as shown in FIG. 9 are made, storage drive 12-1 can be set as the next bootable device, and the node device 10 can then be rebooted to start the conversion process.

As shown in FIG. 9, the node device 10 can be capable of dual booting, from both its existing operating system and the new operating system, at this point in the conversion process. In FIG. 9, partitions associated with the original operating system (OS1) are denoted via shading to distinguish these partitions from those associated with the new operating system.

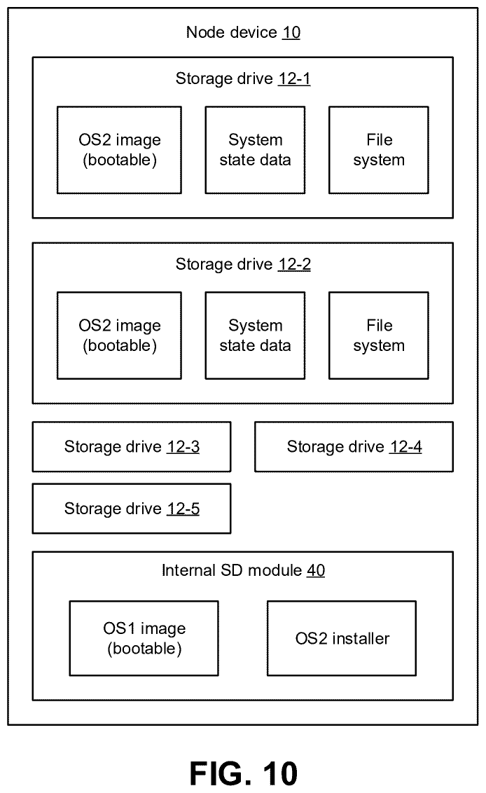

Turning now to FIG. 10, a final state of the node device 10, e.g., after the conversion process has been committed, is shown. While the cluster in which the node device 10 operates is composed of nodes running both the old and new operating systems, the node device 10 can maintain compatibility between the operating systems. However, once all of the nodes in the cluster have been converted, a commit-like step can be performed that can serve as a point of no return for the conversion. This step can result in the node device 10 resembling a factory-prepared ready node, as shown in FIG. 10.

As part of the step shown in FIG. 10, the conversion process can ensure that there is redundancy with the boot devices of the node device 10. This can be done by reclaiming space from one or more other data drives (e.g., storage drive 12-2) to mirror with the current boot device (e.g., storage drive 12-1). Other techniques for facilitating redundancy with boot devices can also be used. Lastly, relevant portions of the files associated with the conversion process, such as images and/or installers for both operating systems associated with the conversion, can be placed at a storage location of the node device 10, such as one or more storage drives 12, an internal secure digital (SD) (card) module 40, and/or other suitable locations.

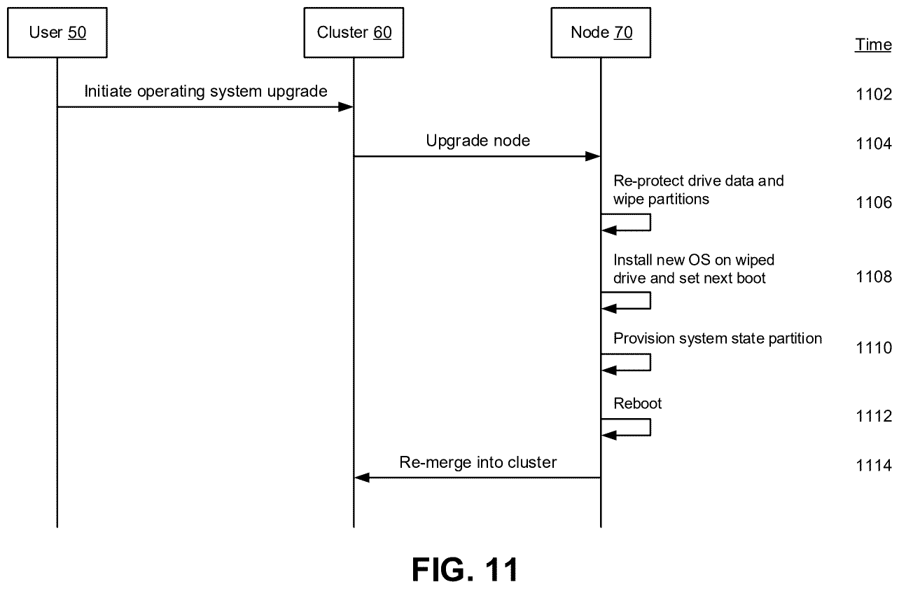

Turning next to FIGS. 11-13, diagrams illustrating respective procedures that can be performed in connection with one or more implementations described herein are illustrated. Referring to FIG. 11, an example procedure that can be performed to convert the operating system of a node 70 of a cluster 60 is illustrated. The procedure shown by FIG. 11 begins at time 1102, in which a user 50 can initiate an operating system upgrade for devices in the cluster 60. The cluster 60, in turn, can initiate an upgrade of the node 70 at time 1104.

At time 1106, the upgrade process at the node 70 can begin by wiping a drive of the node 70 to create space for the new operating system. As shown, this process can include migrating partitions and/or otherwise re-protecting any data stored on the target drive to other drives, and the upgrade process can wait until this re-protection process is complete before wiping the partitions of the drive.

At time 1108, the new operating system can be installed onto the drive of the node 70 that was wiped at time 1106, and that drive can be set as the next boot device. At time 1110, a system state partition can be provisioned, e.g., by creating the partition and moving cluster configuration files to be used once booted from the new operating system to that partition. At time 1112, the node 70 can be rebooted, such that it is now booting the new operating system.

At time 1114, the conversion process for the node 70 is complete, and the node 70 can be re-merged back into the cluster 60. The process shown at times 1104-1114 can then be repeated until all nodes 70 in the cluster 60 have been upgraded.

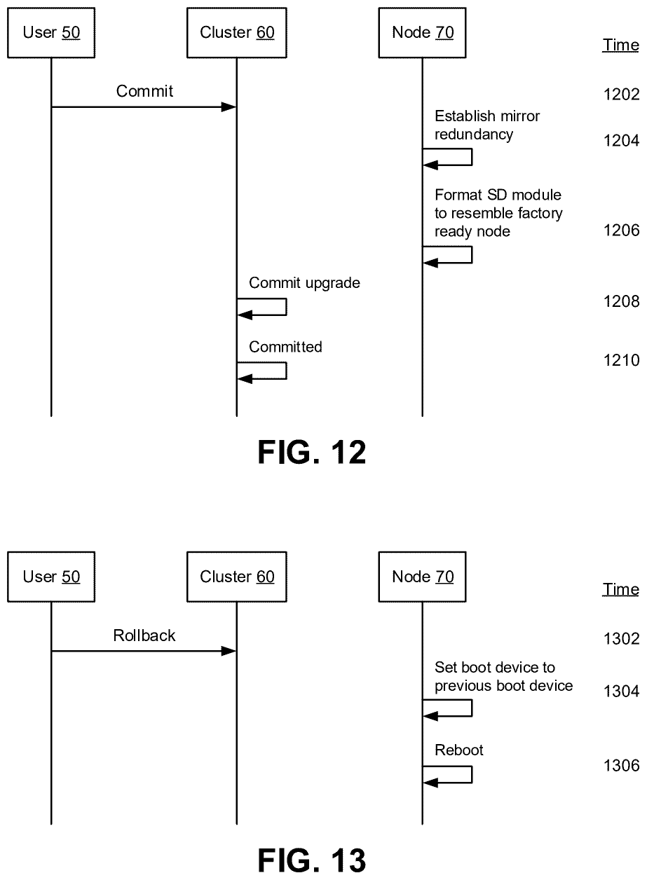

Referring next to FIG. 12, a procedure that can be used to facilitate committing an operating system conversion on nodes 70 of a cluster 60 is shown. The process shown in FIG. 12 can begin at time 1202, in which a user 50 submits a commit-like command to the cluster 60. The node 70 can then establish mirror redundancy of its boot devices at time 1204 and format an SD module or other storage device to resemble a factory ready node at time 1206. The result of the operations performed by the node 70 at times 1204 and 1206 can result in the node being structured similarly to that shown by FIG. 10.

Once all nodes have completed the operations performed at times 1204 and 1206, the cluster can commit the upgrade at time 1208. As a result of the upgrade successfully being committed, the upgrade is completed at time 1210.

With reference now to FIG. 13, a procedure that can be used to facilitate rolling back an operating system conversion on a node 70 of a cluster 60 is shown. The process shown in FIG. 13 can (optionally) begin at time 1302, in which a user 50 submits a rollback command to the cluster 60. It is noted, however, that a rollback could be initiated by other means, such as independently by the cluster 60 in response to encountering an error or for other reasons.

Subsequent to a rollback being initiated, if any configuration changes were made during the conversion but prior to the rollback, the rolled back version of the previous operating system of the node 70 can be configured to see those configuration updates while looking at the system state partition as an alternate location for critical configuration files. As a result, the node 70 can simply set its boot device to the previous boot device (on which the previous operating system is stored) at time 1304, and reboot to the previous boot device at time 1306, while referring to the system state partition to preserve the state of the node 70 and ensure continuity of service.

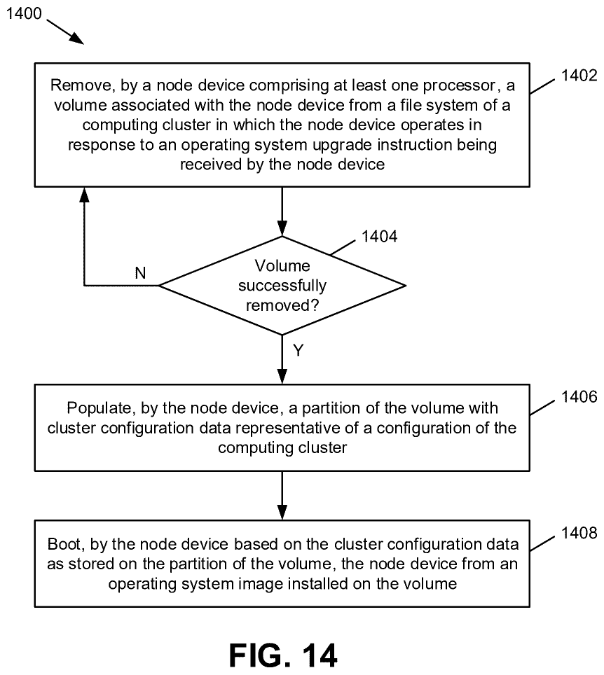

Turning to FIG. 14, a flow diagram of a method 1400 that facilitates storage system repurposing with preservation of cluster configuration deltas and data in-place is illustrated. At 1402, a node device (e.g., a node device 10) comprising a processor (e.g., a processor 104) can remove (e.g., by a storage preparer 110) a volume (e.g., a storage drive 12) associated with the node device from a file system of a computing cluster in which the node device operates in response to an operating system upgrade instruction being received by the node device.

At 1404, the node device can determine whether the volume has been successfully removed from the file system of the cluster. If the volume is not successfully removed, method 1400 can return to 1402 to re-attempt removal of the volume. Once the removal is successful, method 1400 can proceed from 1404 to 1406, at which the node device can populate (e.g., by a storage populator 120) a partition of the volume removed at 1402 with cluster configuration data representative of a configuration of the computing cluster.

At 1408, the node device can boot (e.g., by a boot module 130) the node device from an operating system image installed on the volume processed at 1406 based on the cluster configuration data as stored on the partition of the volume at 1406.

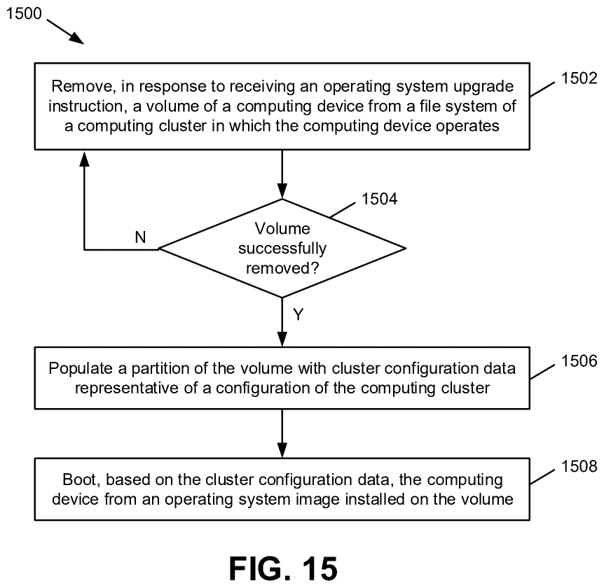

Referring next to FIG. 15, a flow diagram of a method 1500 that can be performed by at least one processor, e.g., based on machine-executable instructions stored on a non-transitory machine-readable medium, is illustrated. An example of a computer architecture, including a processor and non-transitory media, that can be utilized to implement method 1500 is described below with respect to FIG. 16.

Method 1500 can begin at 1502, in which the at least one processor can remove, in response to receiving an operating system upgrade instruction, a volume of a computing device from a file system of a computing cluster in which the computing device operates.

At 1504, the at least one processor can determine whether the volume has been successfully removed, e.g., to prevent method 1500 from proceeding past 1502 until removal of the volume. Once the volume has been successfully removed, method 1500 can proceed from 1504 to 1506.

At 1506, the at least one processor can populate a partition of the volume removed at 1502 with cluster configuration data representative of a configuration of the computing cluster.

At 1508, the at least one processor can boot, based on the cluster configuration data written at 1506, the computing device from an operating system image installed on the volume.

FIGS. 14-15 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 16 and the following discussion are intended to provide a brief, general description of a suitable computing environment 1600 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 16, an example general-purpose environment 1600 for implementing various embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD), a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth.

For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
removing a storage drive, of a node device of a computing system, from a file system used by the computing system in response to receiving an operating system upgrade instruction for the node device;
in response to determining that the storage drive has successfully been removed from the file system, populating a partition of the storage drive with system configuration data representative of a configuration of the computing system; and
booting, based on the system configuration data as stored on the partition of the storage drive, the node device from an operating system image installed on the storage drive.

2. The system of claim 1, wherein the operations further comprise:
in further response to determining that the storage drive has successfully been removed from the file system, installing the operating system image on the storage drive.

3. The system of claim 1, wherein the operating system image corresponds to a first operating system, wherein the storage drive is a first storage drive of the node device, and wherein the first storage drive is different from a second storage drive of the node device from which a second operating system, different from the first operating system, is executed.

4. The system of claim 3, wherein the operations further comprise:
in response to receiving an upgrade commit instruction, removing the second operating system from the second storage drive of the node device.

5. The system of claim 1, wherein the operations further comprise:
recording configuration change data, representative of a change to the configuration of the computing system made after completion of the booting, to the partition of the storage drive.

6. The system of claim 5, wherein the operating system image is a first operating system image, wherein the storage drive is a first storage drive, and wherein the operations further comprise:
in response to receiving a rollback instruction, booting, based on the system configuration data and the configuration change data, the node device from a second operating system image stored on a second storage drive of the node device.

7. The system of claim 1, wherein the operations further comprise:
selecting the storage drive of the node device from a group of storage drives of the node device in response to determining that the storage drive contains no partitions that are mirrored to other node devices, other than the node device, of the computing system.

8. The system of claim 1, wherein the node device is a first node device, wherein the partition of the storage drive is a first partition, and wherein the operations further comprise:
migrating, prior to the removing of the storage drive from the file system, a second partition of the storage drive that is mirrored to a second node device of the computing system from the first node device to a third node device of the computing system that is not the first node device or the second node device.

9. The system of claim 1, wherein the partition of the storage drive is a first partition, and wherein the operations further comprise:
transferring stored contents of the storage drive to other storage drives, other than the storage drive, associated with the computing system; and
removing second partitions of the storage drive from a partition structure of the storage drive, wherein the removing of the storage drive from the file system is further in response to successful completion of the transferring and the removing of the second partitions.

10. A method, comprising:
removing, by a node device comprising at least one processor, a volume associated with the node device from a file system of a computing cluster in which the node device operates in response to an operating system upgrade instruction being received by the node device;
in response to determining that the volume has successfully been removed from the file system of the computing cluster, populating, by the node device, a partition of the volume with cluster configuration data representative of a configuration of the computing cluster; and
booting, by the node device based on the cluster configuration data as stored on the partition of the volume, the node device from an operating system image installed on the volume.

11. The method of claim 10, further comprising:
installing, by the node device in further response to determining that the volume has successfully been removed from the file system of the computing cluster, the operating system image on the volume.

12. The method of claim 10, wherein:
the operating system image corresponds to a first operating system,
the volume is a first volume of the node device,
the first volume is different from a second volume of the node device from which a second operating system, distinct from the first operating system, is executed, and
the method further comprises:
removing, by the node device in response to an upgrade commit instruction being received by the node device, the second operating system from the second volume of the node device.

13. The method of claim 10, further comprising:
recording, by the node device, configuration change data, representative of a change to the configuration of the computing cluster made after completion of the booting, to the partition of the volume.

14. The method of claim 13, wherein the operating system image is a first operating system image, wherein the volume is a first volume, and wherein the method further comprises:
in response to a rollback instruction being received at the node device, booting, by the node device based on the cluster configuration data and the configuration change data, the node device from a second operating system image stored on a second volume of the node device.

15. The method of claim 10, wherein the partition of the volume is a first partition, and wherein the method further comprises:
transferring, by the node device, stored contents of the volume to other volumes, other than the volume, associated with the computing cluster; and
removing, by the node device, second partitions of the volume from a partition structure of the volume, wherein the removing of the volume from the file system is further in response to successful completion of the transferring and the removing of the second partitions.

16. A non-transitory machine-readable medium comprising computer executable instructions that, when executed by at least one processor, facilitate performance of operations, the operations comprising:
removing, in response to receiving an operating system upgrade instruction, a volume of a computing device from a file system of a computing cluster in which the computing device operates;
in response to determining that the volume has successfully been removed from the file system of the computing cluster, populating a partition of the volume with cluster configuration data representative of a configuration of the computing cluster; and
booting, based on the cluster configuration data, the computing device from an operating system image installed on the volume.

17. The non-transitory machine-readable medium of claim 16, wherein the operations further comprise:
installing, in further response to determining that the volume has successfully been removed from the file system of the computing cluster, the operating system image on the volume.

18. The non-transitory machine-readable medium of claim 16, wherein:
the operating system image corresponds to a first operating system,
the volume is a first volume of the computing device,
the first volume is different from a second volume of the computing device on which a second operating system, different from the first operating system, is stored, and
the operations further comprise:
removing, in response to receiving an upgrade commit instruction, the second operating system from the second volume of the computing device.

19. The non-transitory machine-readable medium of claim 16, wherein the operating system image is a first operating system image, wherein the volume is a first volume, and wherein the operations further comprise:
recording configuration change data, representative of a change to the configuration of the computing cluster after the booting, to the partition of the volume; and
in response to receiving a rollback instruction, booting, based on the cluster configuration data and the configuration change data, the computing device from a second operating system image stored on a second volume of the computing device.

20. The non-transitory machine-readable medium of claim 16, wherein the partition of the volume is a first partition, and wherein the operations further comprise:
transferring stored contents of the volume to other volumes, other than the volume, associated with the computing cluster; and
removing second partitions of the volume from a partition structure of the volume, wherein the removing of the volume from the file system is further in response to successful completion of the transferring and the removing of the second partitions.
